(19) United States
(12) Patent Application Publication
(10) Pub. No.: US 2026/0264891 A1
(43) Pub. Date: Sep. 10, 2026

(54) RECUPERATIVE LINE ROUTING FOR SPACECRAFT THERMAL RADIATORS

(71) Applicant: Government of the United States as represented by the Secretary of the Air Force, Wright-Patterson AFB, OH (US)

(72) Inventor: Jonathan Allison, Albuquerque, NM (US)

(21) Appl. No.: 19/069,341

(22) Filed: Mar. 4, 2025

(51) Int. Cl. B64G 1/50

(52) U.S. Cl. CPC B64G 1/503

(57) ABSTRACT

A recuperative line routing system for spacecraft. The recuperative line routing system includes a pumped fluid loop, the pumped fluid loop having a distribution header in fluid communication with a collection header via a first radiator line and a second radiator line joined to a radiator panel. The first radiator line and the second radiator line each reverse direction at least twice between a distribution header and the collection header to define for each a first and last radiator line segment. The first radiator line segment of the first radiator line is in relatively close proximity to the last radiator line segment of the second radiator line to define a heat transfer zone.

### TECHNICAL FIELD

The present disclosure relates to thermal control of spacecraft.

### BACKGROUND

During spaceflight, the main goal of thermal control is to maintain temperatures of components (and persons, if crewed spaceflight) within allowable limits with minimal complexity, maximum reliability and minimal use of resources like electrical power, mass, and money. Spacecraft often use pumped fluid loops for thermal control. Pumped fluid loops utilize fluid flow in pipes (or, synonymously, tubing) to provide for heat transfer via convection and conduction, and ultimately via radiation from a heat sink such as a radiator external to the spacecraft.

Pumped fluid loops provide the attractive advantage of permitting turndown that enables thermostatic operation of temperature adjustment within allowable limits in varying thermal environments. Turndown refers to the ability to reduce the rate of heat transfer when desired and is generally achieved via a bypass line that bypasses the thermal radiator. Typically, a thermostatic mixing (or splitting) valve allocates flow to the bypass line as required to maintain payload temperature via a feedback control loop. In such designs, at high turndown ratios (i.e. when only a little heat transfer is required) there is a low flowrate through the radiator lines. This results in nonlinear thermal behavior because as radiator flow rate decreases, the fluid spends more time in the radiator and becomes colder than it would at higher flow rates. Thus, the thermostatic mixing valve must ‘chase’ the problem in order to cut flow rates sufficiently to achieve a desired amount of heat rejection at a fixed outlet mix temperature.

A difficult confounding factor in thermal control via pumped fluid loops is that the effective thermal radiation sink environment of a spacecraft radiator can vary dramatically—-from a sink temperature as high as 300 Kelvin to as low as 3 Kelvin (the background temperature of deep space). This variation happens as the spacecraft's radiator is in sunlight, body-shading, and eclipse. The spacecraft should be designed to function with its maximum internal heat loads while the radiator is sunlit but also to function with minimum internal heat loads while the spacecraft is in eclipse, all the while maintaining the flow delivered back to the spacecraft at constant temperature.

As discussed above, at very low turndowns, the fluid may naturally approach the sink temperature because heat internally generated by the spacecraft is not sent to the thermal radiator. This is because in cold cases, the spacecraft needs to preserve its heat and does not need to send it to the radiator. When heat from the spacecraft is not sent to the radiator, fluid in the radiator can freeze or turn slushy, and other components can get too cold for proper operation. Current solutions involve heating the radiator to prevent harmful freezing, but this solution is relatively wasteful and costly.

There is a continuing unmet need for a pumped fluid loop thermal control system that minimizes or eliminates excessively cold fluid channels in a spacecraft heat sink, e.g., a radiator.

### BRIEF DESCRIPTION OF THE DRAWINGS

The following detailed description of embodiments of the present disclosure can be best understood when read in conjunction with the drawings enclosed herewith:

FIG. 1 is a schematic diagram of prior art pumped fluid loop system;

FIG. 2 is a schematic diagram of prior art pumped fluid loop system with a recuperative heat exchanger;

FIG. 3 is a schematic diagram of an example pumped fluid loop recuperative line routing heat exchange system;

FIG. 4 is a schematic diagram of an example pumped fluid loop recuperative line routing heat exchange system;

FIG. 5 is a schematic diagram of an example pumped fluid loop recuperative line routing heat exchange system;

FIG. 6 is a schematic diagram of an example pumped fluid loop recuperative line routing heat exchange system;

FIG. 7 is a schematic diagram of an example pumped fluid loop recuperative line routing heat exchange system;

FIG. 8 is a schematic diagram of an example pumped fluid loop recuperative line routing heat exchange system;

FIG. 9 is a schematic diagram of an example pumped fluid loop recuperative line routing heat exchange system;

FIG. 10 is a schematic diagram of an example pumped fluid loop recuperative line routing heat exchange system;

FIG. 11 is a schematic diagram of an example pumped fluid loop recuperative line routing heat exchange system; and

FIG. 12 is a schematic diagram of an example pumped fluid loop recuperative line routing heat exchange system.

The embodiments set forth in the drawings are illustrative in nature and not intended to be limiting. Moreover, individual features of the drawings and the disclosure will be more fully apparent and understood in view of the detailed description.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific FIG. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

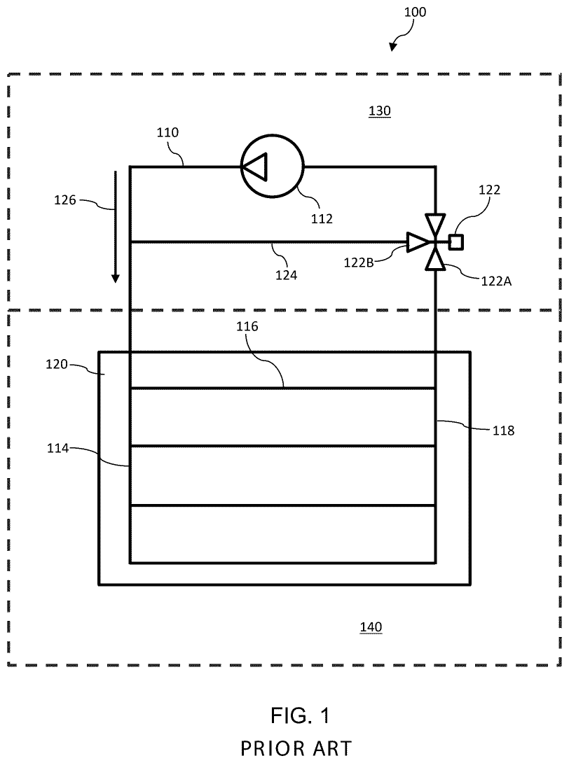

Referring to FIG. 1, there is shown schematically a conventional system 100 for pumped fluid loop heat exchange for heat transfer between a thermostatically controlled interior space 130 and an exterior space 140. In an embodiment, the interior space 130 can be that of a spacecraft, and the exterior space 140 can be outer space. A closed loop of lines 110 enclose a fluid that is pumped by pump 112 in a continuous loop in a direction such as that indicated by arrow 126 to a radiator panel 120. The closed loop of lines 110 includes a distribution header 114 joined in fluid communication to one or more radiator fluid lines 116 that each are in fluid communication with a collection header 118 that collects the flowing fluid and directs it back to the pump 112. To achieve turndown in the conventional system 100, a thermostatic mixing (or splitting) valve 122 can facilitate fluid flow through a bypass line 124. The valve 122 can be at least partially closed at 122A to flow from the collection header and at least partially open at 122B to flow through the bypass line. The radiator panel can be made of metal, including aluminum, copper, titanium, stainless steel (e.g., 304 stainless steel), niobium-zirconium (e.g., Nb-1% Zr), titanium-aluminum-vanadium (e.g., Ti-6% Al-4% V) or any other metal suitable for use in space, as well as polymers, such as carbon fiber composites. The radiator panel can also include coatings that fully or partially coat the radiator panel, such as black paint, reflective layers, silver Teflon, and/or multilayer insulation.

Continuing to refer to FIG. 1, in a conventional system it is understood that the thermal conductance of thermal radiation off the radiator is so much poorer than the thermal conductance by conduction and convection in the pumped fluid loop and radiator that the boundary condition experienced by the fluid lines is a state of constant heat flux. In this condition, the heat spreads out uniformly across the radiator panel 120 because the heat transfer to space off the radiator is so poor. At high turndown ratios (i.e. when only a little heat transfer to radiator 120 is required) there is a low flowrate through the radiator lines. In typical designs, in cases where internally generated heat, that the pumped fluid loop is designed to sink, is not present or negligible, fluid temperature can approach the sink temperature. Sink temperatures in outer space can range from 200K (−3 C) to 3K (−250 C). Issues with thermal control in the interior space 130 can develop when sink temperatures are 150K or lower because most spacecraft coolant fluids used in pumped fluid loop systems can have minimum operating temperatures of, for example, between 250K and 200K.

Different fluids used in pumped fluid loops have different minimum operating temperatures, but fluids used in pumped fluid loops tend to have minimum service temperatures that range from −80° C. to −130° C. depending on the fluid. As different fluids cool down to temperatures below which flow is possible, fluids with different sized molecules can behave in different ways. In certain fluids small molecules such as ammonia can freeze. Larger polymers can exhibit increased dramatically viscosity to the point that they no longer pour out of a glass (the ‘pour point’). A propylene glycol-water mixture can become slushy at the minimum surface temperatures, thereby rendering them less desirable as the pumped fluid. Even above the pour point, polymers can be viscous enough that the pump may be driven outside of its operating envelope which is very tightly and carefully defined so as to ensure that the pump does not damage itself during operation. Another issue that can occur is that if a parallel flow radiator has one of the parallel legs colder than the rest, that leg's fluid's viscosity can increase, decreasing flow to that leg, further reducing its temperature. This could cascade into undesigned-for operational modes or even a frozen leg.

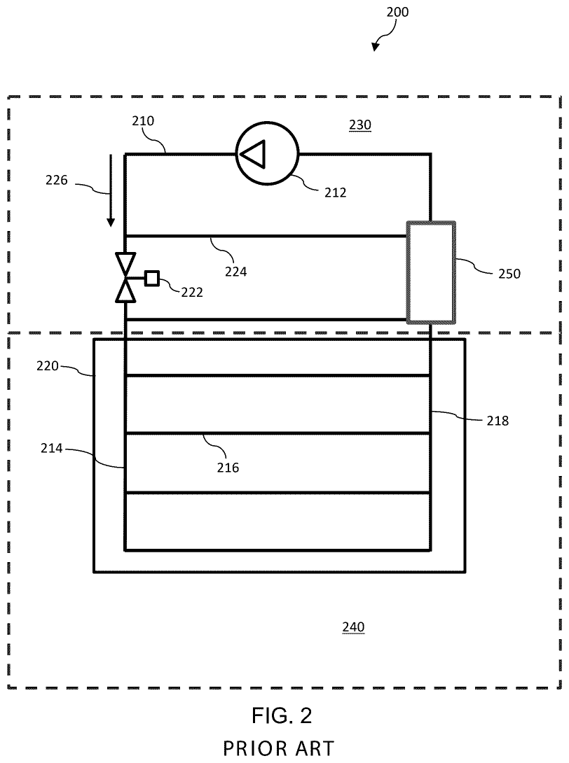

One solution to prevent the fluid in the radiator from becoming excessively cold is shown schematically in FIG. 2 as a second system 200 example for pumped fluid loop systems. FIG. 2 includes the components and features of the pumped fluid loop described in FIG. 1 but includes a recuperative heat exchanger 250. The second system 200 utilizes a pumped fluid loop heat exchange for heat transfer between a thermostatically controlled interior space 230 and an exterior space 240. In an embodiment, the interior space 230 can be that of a spacecraft, and the exterior space 240 can be outer space. A closed loop of lines 210 enclose a fluid that is pumped by pump 212 in a continuous loop in a direction such as that indicated by arrow 226 to a radiator panel 220. The closed loop of lines 210 includes a distribution header 214 joined in fluid communication to one or more radiator fluid lines 216 that each are in fluid communication with a collection header 218 that collects the flowing fluid and directs it back to the pump 212. To achieve turndown in the conventional approach, a thermostatic mixing (or splitting) valve 222 can facilitate fluid flow through a bypass line 224. The valve 122 can be at least partially closed to flow to the distribution header and at least partially open to flow through the bypass line 224 to the recuperative heat exchanger 250. The recuperative heat exchanger 250 can be positioned just before and after the radiator and bypass line 224 to permit full flow through the radiator while driving radiator temperature across the radiator to be much closer to the radiative average temperature, thus ‘holding up’ the cold temperature. While effective, a recuperative heat exchanger 250 adds mass, cost, and complexity to pumped fluid loop system.

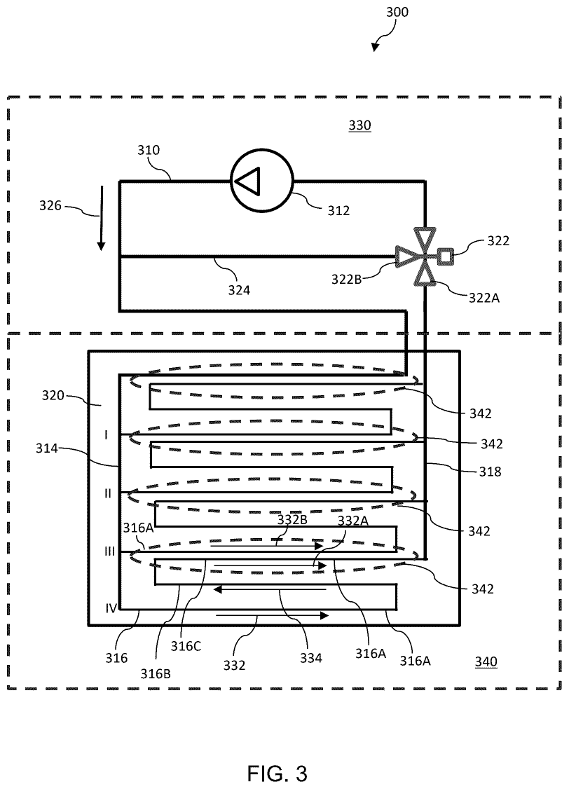

Referring to FIG. 3, there is shown an embodiment of a recuperative line routing heat exchange system 300 for pumped fluid loop heat exchange for heat transfer between a thermostatically controlled interior space 330 and an exterior space 340. The recuperative line routing heat exchange system 300 utilizes recuperative line routing heat exchange in or on a radiator panel 320. In an embodiment, the interior space 330 can be that of a spacecraft, and the exterior space 340 can be outer space. A closed loop of lines 310 enclose a fluid that is pumped by pump 312 in a continuous loop in a direction such as that indicated by arrow 326 to the radiator panel 320. The closed loop of lines 310 includes a distribution header 314 joined in fluid communication to one or more radiator fluid lines 316 that each are in fluid communication with a collection header 318 that collects the flowing fluid and directs it back to the pump 312. To achieve turndown in the conventional approach, a thermostatic mixing (or splitting) valve 322 can facilitate fluid flow through a bypass line 324. The valve 322 can be at least partially closed at 322A to flow from the collection header and at least partially open at 322B to flow through the bypass line.

For the radiator panel 320, and all radiator panels referred to and disclosed herein for each example disclosed, typical radiator fluid lines can be comprised of steel, titanium, or aluminum and can range in diameter range from about 0.125″ to about 0.375″, with wall thickness of a few thousandths of an inch. Radiator fluid lines can be bent to route in serpentine fashion across the radiator, resulting in a plurality of radiator leg segments, and each of the plurality of radiator leg segments can be oriented in a generally parallel relationship. Radiator fluid lines can be attached to the radiator by an adhesive, including an adhesive that is pliable to fill in the gaps between the radiator lines and the relatively flat radiator. Saddles to adapt from round tubing to flat radiators can also be used. Extruded tubing with integral flat flanges can be used for radiator lines. Radiator lines can ‘jump’ over other lines by being bent off the radiator. Radiator lines need not contact the radiator across their entire length, but in embodiments the line length in contact with the radiator can transfer heat to the radiator, thus the majority of line length can be generally in contact. Except in heat transfer zones, as described below, radiator lines can be spaced about 6-8″ apart, which is believed to be mass-optimal given radiator thermal properties and the Stefan-Boltzmann law of radiation. Bent sections of radiator lines need not be attached to the radiator, and in an embodiment are not attached to the radiator. The radiator panel may consist of a honeycomb panel or other structural shape and can be made of aluminum due to its good strength-to-weight and thermal-conductivity-to-weight ratios.

Radiator panels disclosed herein can be made the materials disclosed above, as well as materials such as aluminum alloy, beryllium, magnesium, and/or carbon fiber. Construction can be honeycomb core, skin-and-stringer, machined isogrid, monococque fiber composite, or any other construction that achieves desired lightweight, strength, and stiffness in the context of the system use. Pumped fluid lines can be bent at the line manufacturer, assembled (welding and/or threaded joints), and integrated into the spacecraft as a large assembly. Line assemblies can then be threaded or welded together on the spacecraft. Lines can be attached to the spacecraft by means of an integral flange or attached saddle. A thermal interface material can be utilized as part of adhering the line to the radiator surface to provide both heat transfer and the small amount of structural support. In places where the line needs to stand off the panel, separate standoff structures made of metal or plastic with zip ties can support the lines to prevent them from shaking excessively during launch. Joints in the lines such as elbows and tees can be welded in, wide bends can be accomplished via tube-bending materials and processes.

Further for the radiator fluid lines, and all radiator fluid lines referred to and disclosed in the examples herein, typical radiator fluid lines can be routed to be a recuperative line routing heat exchanger by routing segments of radiator fluid lines with relatively warm fluid inside near radiator fluid lines with relatively cooler fluid inside in what is referred to herein as “heat transfer zones.” The fluid pumped through the loop may be a gas, a liquid, a liquid-vapor mixture, a liquid-gas mixture, or any other fluid. In the case of a liquid-vapor mixture, there is generally relatively little sensible temperature difference other than some nominal subcooling and superheating. In an embodiment, in the heat transfer zones, as described below, portions of the radiator line can be spaced about 1″ apart (center-to-center). In embodiments, even tighter spacing distances such as about 0.5″ (center-to-center) could be achieved. Even tighter distances can be achieved by routing the lines within the same saddle, e.g., a saddle with two, opposed sides on which side-by-side tubes can be mounted with very small fractions of an inch in clearance between one another. In an embodiment a thermal interface material (TIM) can be utilized between heat transfer components, such as the radiator lines and the radiator surface, The UA, that is, the overall heat transfer coefficient (the area normalized thermal conductance) of a given heat exchanger, in a recuperative line routing heat exchanger can be achieved by calculating the relative thermal resistance for heat to flow from the bulk temperature of the fluid in the hotter line to the bulk temperature of the fluid in the colder line. Models of system designs as disclosed herein have found that at 1″ spacing the thermal resistance through the radiator is dominant, but that achievably smaller spacings could have the line's wall resistance and the thermal interface material (TIM) become dominant.

A recuperative line routing heat exchanger can be implemented in a number of ways to achieve the needs of specific space missions, as described in the various embodiments below. By way of example, such ways include radiator bypass or recuperative line routing heat exchanger bypass; upstream or downstream thermostatic valves; serial or parallel flow radiators; and parallel-flow, counter-flow, or combination heat exchanger topologies. A recuperative line routing heat exchanger avoids the need to procure a separate recuperative heat exchanger piece-part which can be expensive and relatively heavy. The spacecraft integrator can design the recuperative line routing heat exchanger as a simple extension of the design process for the thermal radiator line routing. A simple model of a particular recuperative line routing heat exchanger found that it incurred less than 1 lb. of mass on the spacecraft. In contrast, the Gemini conventional recuperative heat exchanger is believed to have incurred 9 lbs. of mass on the spacecraft.

Referring again to FIG. 3, the recuperative heat exchange system 300 utilizes parallelized radiator leg segments for heat transfer heat exchange from a first radiator leg segment to a second radiator leg segment. To accomplish heat transfer heat exchange, the radiator lines reverse direction at least twice between the distribution header 314 and the collection header 318. As shown in the representative embodiment of FIG. 3, four radiator fluid lines 316 labeled I-IV are in fluid communication with the distribution header 316, and ultimately with the collection header 318. In the example embodiment shown, each radiator fluid line 316 comprises three generally parallel radiator leg segments, 316A, 316B, and 316C and heat transfer heat exchange can occur in the heat transfer portions of sufficiently spaced adjacent radiator legs, as indicated in FIG. 3 by the dashed heat transfer zones 342.

Four heat transfer zones 342 are indicated by the dashed lines in the system 300 shown in FIG. 3. In each heat transfer zone 342 a radiator leg segment of one radiator fluid line 316 is positioned generally parallel to and in close proximity to a radiator leg segment of an adjacent radiator fluid line 316. As illustrated for radiator fluid line 316 labeled IV, the radiator fluid line 316 can have a first radiator leg segment 316A with fluid flow in the direction indicated by arrow 332, generally in a direction from the distribution header 314 toward the collection header 318. In the second radiator leg segment 316B, fluid flows in the direction indicated by arrow 334, generally in a direction from the collection header 318 toward the distribution header 316. A third radiator segment 316C redirects fluid flow again in the direction from the distribution header 316 toward the collection header 318, indicated by arrow 332A. Fluid from the third radiator segment 316C can flow to the collection header 318 and back to pump 312.

Recuperative heat exchange can be understood with reference to the example embodiment of FIG. 3 and considering the relationship between the segments of radiator fluid line III and the segments of radiator fluid line IV. Third radiator leg segment 316C of radiator fluid line IV with fluid flow in the direction of arrow 332A is positioned in relatively close proximity and generally parallel to first radiator leg segment 316A of radiator fluid line III with fluid flow in the direction of arrow 332B. Due to having recently left the distribution header 314, the fluid in first radiator leg segment 316A of radiator fluid line III is relatively warmer than the fluid in third radiator leg segment 316C of radiator fluid line IV, which has flowed a relatively longer path in/on radiator panel 320 since leaving the distribution header 314. Heat from the fluid in the first radiator leg segment 316A of radiator fluid line III can flow to the fluid in third radiator leg segment 316C of radiator fluid line IV, thereby warming it and minimizing the effects of heat loss and the associated detrimental effects for the fluid while in/on the radiator 320.

The embodiment of a recuperative line routing heat exchange system 300 for pumped fluid loop heat exchange can be described as heat exchanger comprising a radiator panel 320 having at least two radiator fluid lines thermally coupled for heat exchange, and each of the radiator fluid lines in fluid communication with a distribution header and a collection header. Each of the at least two radiator fluid lines has a radiator leg segment in which fluid flows in the same direction in relatively close, parallel proximity to an adjacent radiator leg segment. Heat exchange can occur between relatively close, parallel adjacent radiator leg segments.

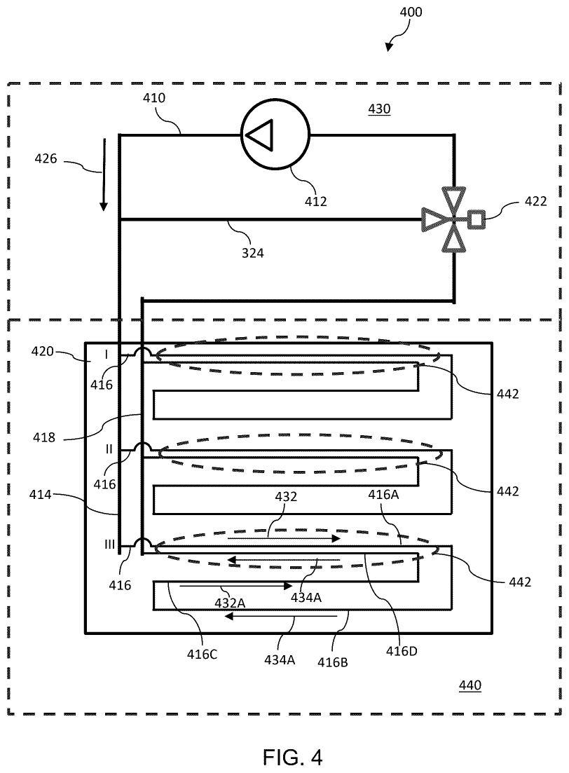

Referring to FIG. 4, there is shown an embodiment of a counter-flow recuperative line routing heat exchange system 400 for pumped fluid loop heat exchange for heat transfer between a thermostatically controlled interior space 430 and an exterior space 440. In an embodiment, the interior space 430 can be that of a spacecraft, and exterior space 440 can be outer space. A closed loop of lines 410 enclose a fluid that is pumped by pump 312 in a continuous loop in a direction such as that indicated by arrow 426 to a radiator panel 420. The closed loop of lines 410 includes a distribution header 414 joined in fluid communication to one or more radiator fluid lines 416 that each are in fluid communication with a collection header 418 that collects the flowing fluid and directs it back to the pump 412. To achieve turndown in the conventional approach, a thermostatic mixing (or splitting) valve 422 can facilitate fluid flow through a bypass line 424. The valve 422 can be at least partially closed to flow from the collection header and at least partially open to flow through the bypass line.

The counter-flow recuperative line routing heat exchange system 400 utilizes relatively closely spaced and parallel radiator leg segments for counter-flow heat exchange from a first radiator leg segment to a second radiator leg segment. To accomplish counter-flow heat exchange, the radiator fluid lines reverse direction at least once between the distribution header 414 and the collection header 418. In the example embodiment shown, each radiator fluid line 416 comprises four generally parallel radiator leg segments, 416A, 416B, 316C and 416D and counter-flow heat exchange can occur in the counter-flow portions the radiator fluid line, as indicated in FIG. 4 by the dashed heat transfer zones 442.

As shown in the representative embodiment of FIG. 4, three radiator fluid lines 416 labeled I-III are in fluid communication with the distribution header 414, and ultimately with the collection header 418. Three heat transfer zones 442 are indicated by the dashed lines. In each heat transfer zone 442 a radiator leg segment of one radiator line is positioned generally parallel to and in close proximity to a radiator leg segment of an adjacent radiator line. As illustrated by way of example for radiator fluid line 416 labeled III, each radiator fluid line 416 can have a first radiator leg segment 416A with fluid flow in the direction indicated by arrow 432, and a second radiator leg segment 416B, fluid flows in the direction indicated by arrow 434, generally in a direction toward the collection header 318 and back toward the distribution header 316. A third radiator leg segment 416C redirects fluid flow again away from the distribution header 316 and the collection header 418, indicated by arrow 432A. Fluid from the fourth radiator leg segment 416D can flow to the collection header 418 and back to pump 412 in the direction of arrow 434A.

Recuperative heat exchange can be understood with reference to the example embodiment of FIG. 4 and considering the relationship between the segments of radiator fluid line III. First radiator leg segment 416A with fluid flowing in the direction of arrow 432 is positioned in relatively close proximity and generally parallel to fourth radiator leg segment 416D with fluid flowing in the direction of arrow 434A. Due to having recently left the distribution header 414, the fluid in first radiator leg segment 416A is relatively warmer than the fluid in the fourth radiator leg segment 416D, which has flowed a relatively longer path in/on the radiator panel since leaving the distribution header 414. Heat from the relatively warmer fluid in the first radiator leg segment 416A can flow to the relatively cooler fluid in fourth radiator leg segment 416D, thereby warming it and minimizing the effects of heat loss and the associated detrimental effects for the fluid while in/on the radiator panel 420.

The embodiment of a recuperative line routing heat exchange system 400 for pumped fluid loop heat exchange can be described as heat exchanger comprising a radiator panel 420 having at least one radiator fluid line in fluid communication with a distribution header and a collection header. The at least one radiator fluid line has at least two radiator leg segments, and fluid flows in opposite directions in one radiator leg segment relative to the other radiator leg segment.

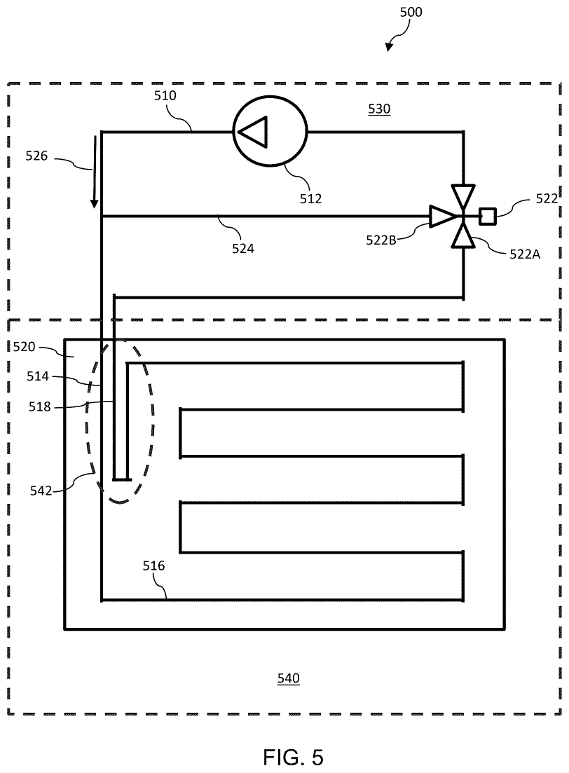

Referring to FIG. 5, there is shown an embodiment of a counter-flow recuperative line routing heat exchange system 500 for pumped fluid loop heat exchange for relatively smaller systems and facilitates heat transfer between a thermostatically controlled interior space 530 and an exterior space 540. In an embodiment, the interior space 530 can be that of a spacecraft, and the exterior space 540 can be outer space. A closed loop of lines 510 enclose a fluid that is pumped by pump 512 in a continuous loop in a direction such as that indicated by arrow 526 to a radiator panel 520. The closed loop of lines 510 includes a distribution header 514 joined in fluid communication to a radiator line 516 that is in fluid communication with a collection header 518 that collects the flowing fluid and directs it back to the pump 512. To achieve turndown in the conventional approach, a thermostatic mixing (or splitting) valve 522 can facilitate fluid flow through a bypass line 524. The valve 522 can be at least partially closed at 522A to flow from the collection header and at least partially open at 522B to flow through the bypass line.

The counter-flow recuperative line routing heat exchange system 500 utilizes relatively closely spaced and parallel radiator line segments for counter-flow heat exchange from the distribution header 514 to the collection header 518. In the example embodiment shown, the collection header 518 includes counter-flow portions adjacent to the distribution header 514, as indicated in FIG. 5 by the dashed counter-flow zone 542. In the illustrated embodiment, fluid flow can leave the distribution header 514 and flow in at least one radiator line 516 and can return to the collection header 518 via one or more counter-flow radiator segments to the collection header 518. A portion of the collection header 518 can also be disposed adjacent and generally parallel to a portion of the distribution header 514 to facilitate heat flow from the relatively warmer fluid in the distribution header 514 to the relatively cooler fluid in the collection header 518 in the vicinity of the radiator panel 520.

Recuperative heat exchange can be understood with reference to the example embodiment of FIG. 5 where one or more passes of the relatively colder end of the radiator line 516 join the collection header 518 disposed adjacent to the relatively hotter end of the distribution header 514 in the counter-flow zone 542. Due to the non-linear nature of thermal radiation, hot spots tend to be localized while cold spots spread over large areas. A small amount of heat goes a long way to drive up temperatures on a cold radiator region. Counter-flow recuperative heat exchanger 500 utilizes can ensure good temperature mixing between the two streams to get the high performance of counterflow heat exchangers alongside the insensitivity-to-uncertainty of counter-flow heat exchangers.

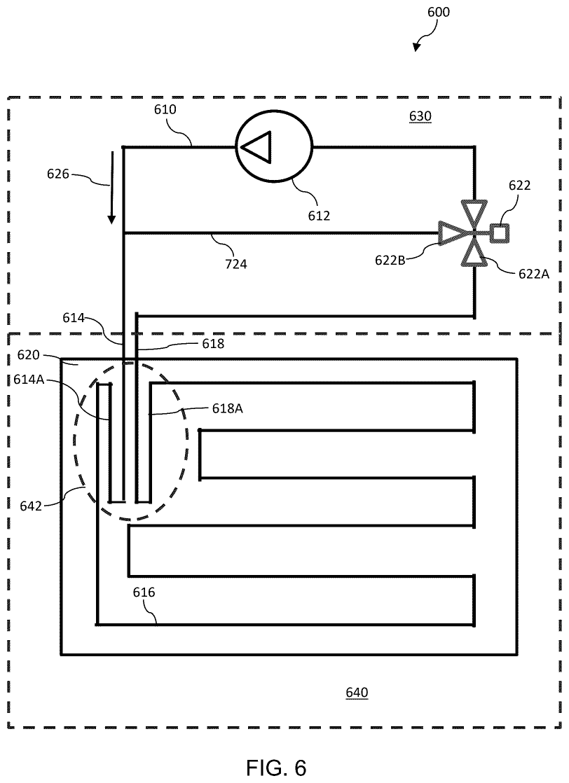

Referring to FIG. 6, there is shown an embodiment of a counter-flow recuperative line routing heat exchange system 600 similar to the counter-flow recuperative heat exchanger 500 shown in FIG. 5. The counter-flow recuperative line routing heat exchange system 600 facilitates heat transfer between a thermostatically controlled interior space 630 and an exterior space 640. In an embodiment, the interior space 630 can be that of a spacecraft, and the exterior space 640 can be outer space. A closed loop of lines 610 encloses a fluid that is pumped by pump 612 in a continuous loop in a direction such as that indicated by arrow 626 to a radiator panel 620. The closed loop of lines 610 includes a distribution header 614 joined in fluid communication to at least one radiator line 616 that is in fluid communication with a collection header 618 that collects the flowing fluid and directs it back to the pump 612. To achieve turndown in the conventional approach, a thermostatic mixing (or splitting) valve 622 can facilitate fluid flow through a bypass line 624. The valve 622 can be at least partially closed at 622A to flow from the collection header and at least partially open at 622B to flow through the bypass line.

The counter-flow recuperative line routing heat exchange system 600 utilizes relatively closely spaced and parallel radiator line segments for counter-flow heat exchange from the distribution header 614 to the collection header 618. In the example embodiment shown, the distribution header 614 and the collection header 618 include counter-flow portions as indicated in FIG. 6 by the dashed counter-flow zone 642. In the illustrated embodiment, fluid flow can enter the distribution header 614 and flow in a double-backed configuration to have at least one adjacent counter-flow portion 614A before leading to the radiator line 616 and can return to the collection header 618 and one or more counter-flow radiator segments 618A to the collection header 618. A portion of the collection header 618 can also be disposed adjacent and generally parallel to a portion of the distribution header 614 to facilitate heat flow from the warm end of the distribution header to the relatively cold portion of the collection header in the vicinity of the radiator panel 620.

Recuperative heat exchange can be understood with reference to the example embodiment of FIG. 6 where one or more passes of the distribution header and the collection header are disposed sufficiently close to one another in the counter-flow zone 642. In an embodiment, the distribution header and the collection header can be spaced at a distance of from between about 0.5 inch and 1.0 inch. Due to the non-linear nature of thermal radiation, hot spots tend to be localized while cold spots spread over large areas. A small amount of heat goes a long way to drive up temperatures on a cold radiator region. counter-flow recuperative heat exchanger 600 utilizes can ensure good temperature mixing between the two streams to get the high performance of counterflow heat exchangers alongside the insensitivity-to-uncertainty of counter-flow heat exchangers.

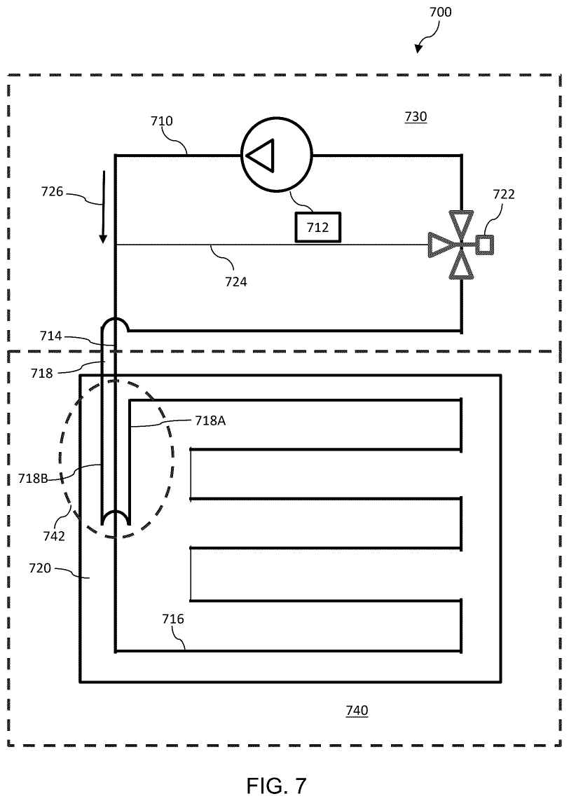

Referring to FIG. 7, there is shown an embodiment of a counter-flow recuperative line routing heat exchange system 700 similar to the counter-flow recuperative line routing heat exchange system 600 shown in FIG. 6, with 700-series numbers corresponding to the 600 series numbers. The counter-flow recuperative heat exchanger 700 facilitates recuperative heat transfer between a portion of the distribution header 714 joined in fluid communication to a radiator line 716 a portion of the collection header 718 that collects the flowing fluid and directs it back to the pump 712. In the embodiment of a counter-flow recuperative heat exchanger 700, the collection header 718 can have at least one portion, such as portion 718A or 718B that is positioned in close, parallel relationship to a portion of the distribution header 714 as it enters the radiator panel 720. In this manner, heat from the relatively hot fluid in the distribution header 714 as it enters the radiator panel 720 can be transferred to the relatively cold fluid in the collection header 718 adjacent in the counter-flow zone 742.

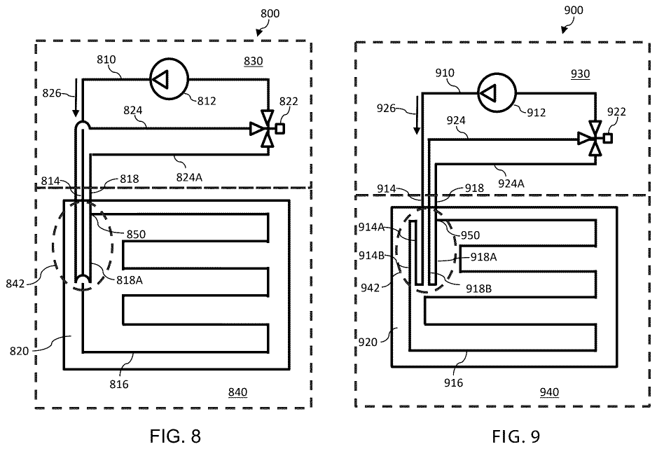

Referring to FIGS. 8 and 9, there is shown two embodiments of a counter-flow recuperative line routing heat exchange systems 800 and 900, respectively, each similar to the counter-flow recuperative line routing heat exchange system 700 shown in FIG. 7, with 700-series numbers corresponding to the 800 and 900 series numbers, respectively. The counter-flow recuperative line routing heat exchange systems 800 and 900 operate similarly to the recuperative line routing heat exchange system 700, but each employ a bypass junction 850 and 950, respectively, on the collection header 818 and 918, respectively, that permits the recuperative heat exchange in the counter-flow zone 842 and 942, respectively, to be bypassed and full flow circulated through bypass line 824A and 924A, respectively.

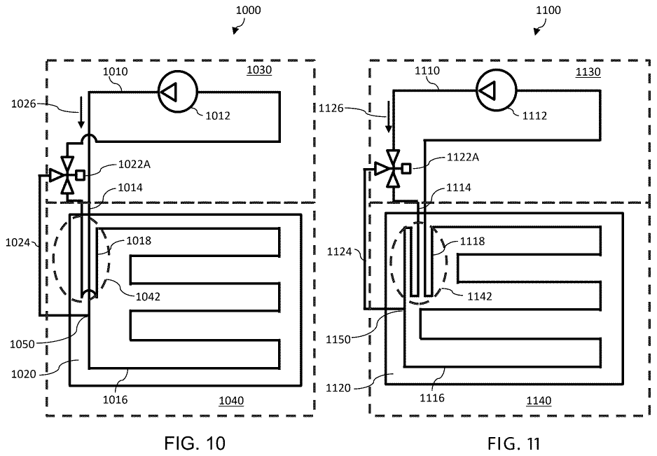

Referring to FIGS. 10 and 11, there is shown two embodiments of a counter-flow recuperative line routing heat exchange systems 1000 and 1100, respectively, each similar to the counter-flow recuperative line routing heat exchange systems 800 and 900 shown in FIGS. 8 and 9, with 800-series numbers and 900-series numbers corresponding to the 1000 and 1100 series numbers, respectively. The counter-flow recuperative line routing heat exchange systems 1000 and 1100 operate similarly to the recuperative line routing heat exchange system 800 and 900, but each employ a bypass junction 1050 and 1150, respectively, on the distribution header 1014 and 1114, respectively, that permits the recuperative heat exchange in the counter-flow zone 1042 and 1142, respectively, to be bypassed and full flow circulated through bypass line 1024A and 1124A, respectively.

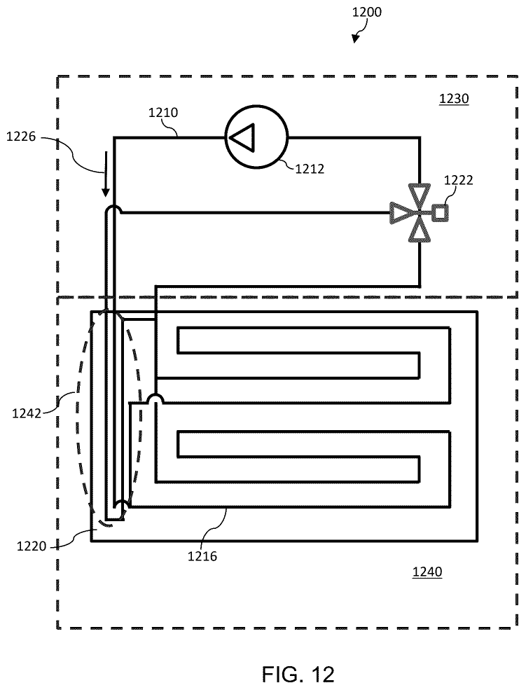

Referring to FIG. 12, there is shown an embodiment of a counter-flow recuperative line routing heat exchange system 1200 similar to the counter-flow recuperative line routing heat exchange system 1000 shown in FIG. 10, with 1200-series numbers corresponding to the 1000 series numbers. The counter-flow recuperative line routing heat exchange system 1200 operates similarly to the recuperative line routing heat exchange system 1000. In the recuperative line routing heat exchange system 1200, the bypass line function can also be accomplished with parallelized radiator with adjacent headers using header-based recuperative line routing for recuperative heat exchange. The example shown in FIG. 12 is a header-based 2× combo co/counterflow heat exchanger.

Having described the disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure. For example, in some embodiments a relatively large radiator may require excessive radiator line length such that the pressure drop to drive the flow through the entire fluid loop could be prohibitively expensive. In such situations, the above-described parallel flow radiators, such as shown in FIG. 3, can be used in which flow is distributed to several legs from a distribution header pipe and recovered in a collection header pipe. The headers can be the same diameter as the lines in the rest of the fluid loop, but the lines in the legs can be a smaller diameter. This approach balances the needs to minimize fluid holdup and minimize pressure drop. Each of the legs may route over the radiator panel once or in multiple serpentine passes. These passes can be referred to as ‘rungs’, e.g., the various fluid flow lines 416 in FIG. 4 can be referred to as rungs. A radiator in which parallel flow is not used is known as a serial radiator. Parallel flow radiators always have less hydraulic resistance than serial flow radiators but are a bit more complicated to build and sometimes are a contributing factor to pumped fluid loop system failures.

All documents cited in the Detailed Description of the Disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A recuperative line routing system for spacecraft, comprising, a pumped fluid loop, the pumped fluid loop having a distribution header in fluid communication with a collection header via a first radiator line and a second radiator line joined to a radiator panel, the first radiator line and the second radiator line each originating at the distribution header and terminating at the collection header;
a fluid pumped by a pump to circulate fluid through the distribution header, through the first radiator line and the second radiator line, and through the collection header;
wherein the first radiator line and the second radiator line each reverse direction at least twice between the distribution header and the collection header to define for each a first and last radiator line segment; and
wherein the first radiator line segment of the first radiator line is in relatively close proximity to the last radiator line segment of the second radiator line to define a heat transfer zone in which heat transfers from the relatively warm fluid in the first radiator line segment of the first radiator line to the relatively cooler fluid in the last radiator line segment of the second radiator line.

2. The recuperative line routing system of claim 1, wherein in the heat transfer zone the fluid in the first radiator line segment of the first radiator line flows parallel to, and in the same direction as, the fluid in the last radiator line segment of the second radiator line.

3. The recuperative line routing system of claim 1, wherein in the heat transfer zone the fluid in the first radiator line segment of the first radiator line flows parallel to, and in the opposite direction as, the fluid in the last radiator line segment of the second radiator line.

4. The recuperative line routing system of claim 1, further comprising a thermostatic valve and a bypass line.

5. The recuperative line routing system of claim 1, wherein a portion of the recuperative line routing system transfers heat from an interior space of a spacecraft to an exterior space.

6. The recuperative line routing system of claim 1, wherein each radiator line comprises a plurality of radiator line segments, each of the plurality of radiator line segments being oriented in generally parallel relationship.

7. The recuperative line routing system of claim 1, wherein the first radiator line segment of the first radiator line is spaced about 0.25 in. to about 1.5 in. from the last radiator line segment of the second radiator line.

8. The recuperative line routing system of claim 1, wherein the radiator panel comprises a honeycomb structure.

9. A recuperative line routing system for spacecraft, comprising,
a pumped fluid loop, the pumped fluid loop having a distribution header in fluid communication with a collection header via radiator line joined to a radiator panel, the radiator line originating at the distribution header and terminating at the collection header;
a fluid pumped by a pump to circulate fluid through the distribution header, through the radiator line, and through the collection header; and
wherein a portion of the distribution header and a portion of the collection header define a heat transfer zone in which heat transfers from the relatively warm fluid in the distribution header to the relatively cooler fluid in the collection header.

10. The recuperative line routing system of claim 9, wherein in the heat transfer zone the fluid in the distribution header flows parallel to, and in the same direction as, the fluid in the collection header.

11. The recuperative line routing system of claim 8, wherein in the heat transfer zone the fluid in the distribution header flows parallel to, and in the opposite direction as, the fluid in the collection header.

12. The recuperative line routing system of claim 9, further comprising a thermostatic valve and a bypass line.

13. The recuperative line routing system of claim 9, wherein a portion of the recuperative line routing system transfers heat from an interior space of a spacecraft to an exterior space.

14. The recuperative line routing system of claim 9, further comprising a plurality of radiator lines, each of the plurality of radiator lines having a plurality of radiator line segments, each of the plurality of radiator line segments being oriented in generally parallel relationship.

15. The recuperative line routing system of claim 9, wherein distribution header is spaced about 0.25 in. to about 1.5 in. from the collection header.

16. The recuperative line routing system of claim 9, wherein the radiator panel comprises a honeycomb structure.

17. A recuperative line routing system for spacecraft, comprising,
a pumped fluid loop, the pumped fluid loop having a fluid pump and a thermostatic mixing valve in a closed loop including a distribution header in fluid communication with a collection header via a first radiator line and a second radiator line joined to a radiator panel, the first radiator line and the second radiator line each originating at the distribution header and terminating at the collection header;
a fluid pumped by a pump to optionally either circulate fluid through the bypass line or to circulate fluid through the distribution header, through the first radiator line and the second radiator line, and through the collection header;
wherein the first radiator line and the second radiator line each reverse direction at least twice between the distribution header and the collection header to define for each a first and last radiator line segment; and
wherein the first radiator line segment of the first radiator line is in close proximity to the last radiator line segment of the second radiator line to define a first heat transfer zone in which heat transfers from the relatively warm fluid in the first radiator line segment of the first radiator line to the relatively cooler fluid in the last radiator line segment of the second radiator line.

18. The recuperative line routing system of claim 17, wherein the first radiator line segment of the first radiator line is spaced about 0.25 in. to about 1.5 in. from the last radiator line segment of the second radiator line.

19. The recuperative line routing system of claim 17, wherein a portion of the distribution header and a portion of the collection header define a second heat transfer zone in which heat transfers from the relatively warm fluid in the distribution header to the relatively cooler fluid in the collection header.

20. The recuperative line routing system of claim 17, wherein the radiator panel comprises a honeycomb structure.
